(19) United States
(12) Patent Application Publication
(10) Pub. No.: US 2018/0121871 A1
(43) Pub. Date: May 3, 2018

(54) COMPUTER ASSISTED GOODS AND SERVICES TRANSPORT SHARING AND DELIVERY

(71) Applicants: Amirabbas Abdollahzadeh, Mercer Island, WA (US); Erfan Mehdibeik, Kirkland, WA (US)

(72) Inventors: Amirabbas Abdollahzadeh, Mercer Island, WA (US); Erfan Mehdibeik, Kirkland, WA (US)

(21) Appl. No.: 15/342,089

(22) Filed: Nov. 2, 2016

(51) Int. Cl. G06Q 10/08

(52) U.S. Cl. CPC G06Q 10/0835

(57) ABSTRACT

A method and a device are disclosed including network-based remote servers and services offered to enable multiple remote unassociated users of computing devices to seek and offer goods and services using shared transportation. A Goods Transport Sharing (GTS) and delivery system may allow a user to request, via an app on a computing device, delivery of goods, sometimes person-to-person. The GTS also allows other users to register as transportation service providers. The GTS matches a requester to a transporter to conduct a business transaction. The GTS allows multi-hop shared transportation and also pickup and delivery from and to third-party participants distinct from the requester. The GTS may further enable ordering of goods from online and delivery of the same goods from a local store. The transportation may span the whole globe and is not limited to a city. The transporter may also perform services distinct from the transportation service.

### TECHNICAL FIELD

This application relates generally to transport sharing. More specifically, this application relates to sharing of transportation between unrelated people to transport and/or deliver goods and/or perform services.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3 shows an example Goods Transport Sharing (GTS) basic environment utilizing the computing device of FIG. 2;

FIG. 4A shows an example GTS system in environment of FIG. 3 using mobile devices and servers similar to those shown in FIGS. 1 and 2;

FIG. 4B shows an example hardware and software architecture of the example GTS system in environment of FIG. 4A;

FIG. 5 shows an example interaction for delivery of goods and services in the example GTS environment of FIGS. 4A and 4B;

FIG. 6 shows an example interaction with a third party in the example GTS environment of FIGS. 4A and 4B;

FIG. 7 shows an example multi-hop interaction in the example GTS environment of FIGS. 4A and 4B; and

FIG. 8 shows an example interaction with an online sales outlet associated with a local store for delivery of goods and services in the example GTS environment of FIGS. 4A and 4B.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references transportation of common goods and packages, it will be appreciated that the disclosure may be used with other types of objects and services and also people, such as taking people to doctor and dentist visits and back as one transaction, assembling purchased items like tables and bicycles, and the like.

Briefly described, a system and a method are disclosed including network-based remote servers and services offered to enable multiple remote unassociated users of computing devices to seek and offer goods and services using shared transportation and delivery. In some embodiments, a Goods Transport Sharing (GTS) system may allow a user to request, via an app on a computing device in communication with the GTS, the transport and delivery of goods and packages from a source to a destination or person-to-person delivery. The GTS also allows other users to register as transportation service providers. Upon receiving a request, the GTS may match a requester to a provider, deliverer, or transporter to conduct a business transaction. The GTS allows multi-hop shared transportation as well as pickup and delivery from and to third-party participants distinct from the requester of transportation. The GTS may allow delivery seven days a week and 24 hours a day after regular business hours and from a particular person to another particular person. The GTS may further enable ordering of goods from an online facility and delivery of the same goods from a local establishment associated with the online facility. The transportation from source to destination may span the whole globe and is not limited to within a city. In some embodiments, the transport provider may also perform services at the source or destination distinct from the transportation service.

With the ubiquity of users' internet access there is an ever increasing demand for expanded services, functionality, online storage, sharing capabilities, and the like. However, one thing the Internet cannot do is to deliver physical goods and services. Internet transports information. That's why even as there are daily advancements in information technology, there is a parallel expansion in mail and package delivery by service providers such as the US Postal Service (USPS), United Parcel Service (UPS)®, Federal Express (FedEx)®, Amazon delivery services being currently developed, and the like. There are also more recent ridesharing services offered by companies such as Uber®, Lyft®, Curb®, Grab®, Ola®, and many more on local, national, and international levels. The internet and mobile computation and communication technologies play an integral role in the ridesharing eco system. They are the communication and computation arms of the transportation system, whether for goods and services or for people. Still, much transportation bandwidth is wasted every hour and every day when vehicles and people that have the capacity and capability to carry some goods between sources and destinations, move without carrying anything. There is a need and an opportunity to tap into and utilize these vast unused resources.

### Illustrative Operating Environment

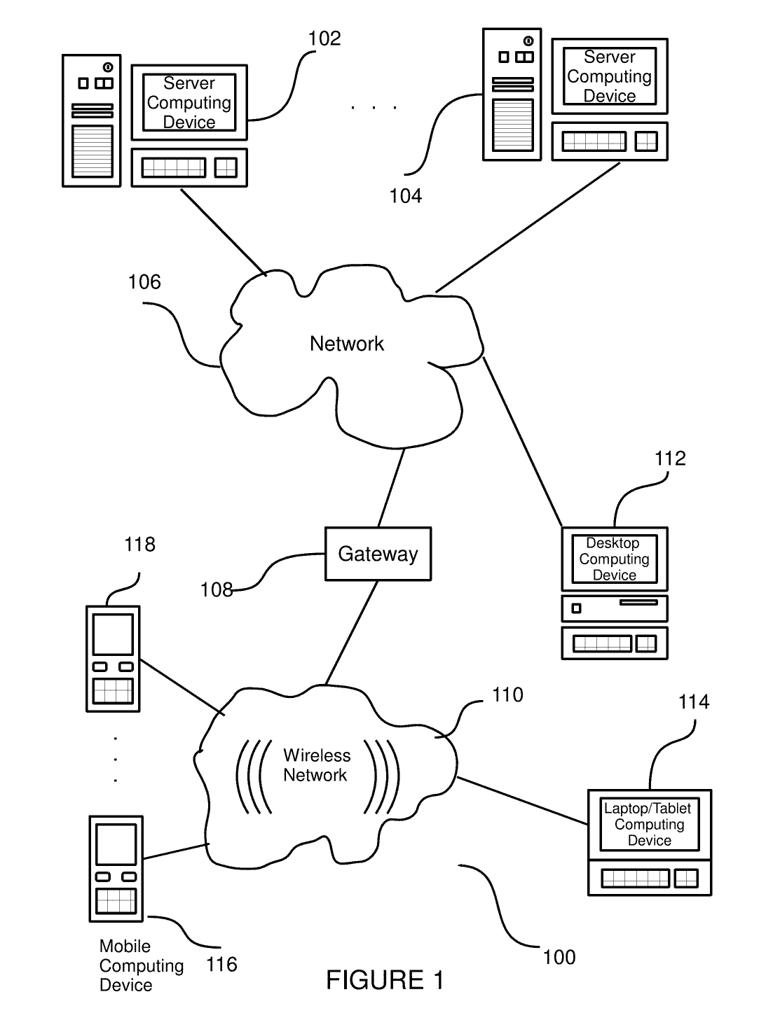

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

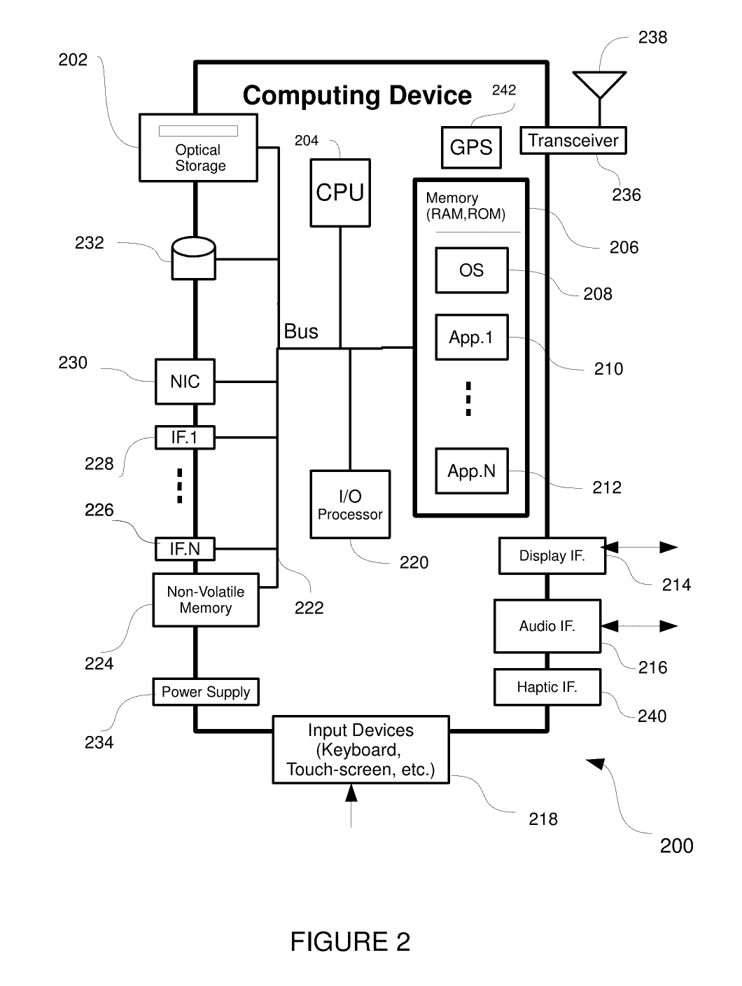

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, Bluetooth Low Energy (LE), High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

In various embodiments, the arrangement of system 100 includes components that may be used in and constitute various networked architectures. Such architectures may include peer-to-peer, client-server, two-tier, three-tier, or other multi-tier (n-tier) architectures, MVC (Model-View-Controller), and MVP (Model-View-Presenter) architectures among others. Each of these are briefly described below.

Peer to peer architecture entails use of protocols, such as P2PP (Peer To Peer Protocol), for collaborative, often symmetrical, and independent communication and data transfer between peer client computers without the use of a central server or related protocols.

Client-server architectures includes one or more servers and a number of clients which connect and communicate with the servers via certain predetermined protocols. For example, a client computer connecting to a web server via a browser and related protocols, such as HTTP, may be an example of a client-server architecture. The client-server architecture may also be viewed as a 2-tier architecture.

Two-tier, three-tier, and generally, n-tier architectures are those which separate and isolate distinct functions from each other by the use of well-defined hardware and/or software boundaries. An example of the two-tier architecture is the client-server architecture as already mentioned. In a 2-tier architecture, the presentation layer (or tier), which provides user interface, is separated from the data layer (or tier), which provides data contents. Business logic, which processes the data may be distributed between the two tiers.

A three-tier architecture, goes one step farther than the 2-tier architecture, in that it also provides a logic tier between the presentation tier and data tier to handle application data processing and logic. Business applications often fall in and are implemented in this layer.

MVC (Model-View-Controller) is a conceptually many-to-many architecture where the model, the view, and the controller entities may communicate directly with each other. This is in contrast with the 3-tier architecture in which only adjacent layers may communicate directly.

MVP (Model-View-Presenter) is a modification of the MVC model, in which the presenter entity is analogous to the middle layer of the 3-tier architecture and includes the applications and logic.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs and/or software modules/components 210-212. Such software modules and components may be stand-alone application software or be components, such as DLL (Dynamic Link Library) of a bigger application software. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client-side and/or mobile communication operating system such as Windows Mobile™, Android®, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC (Media Access Control) address.

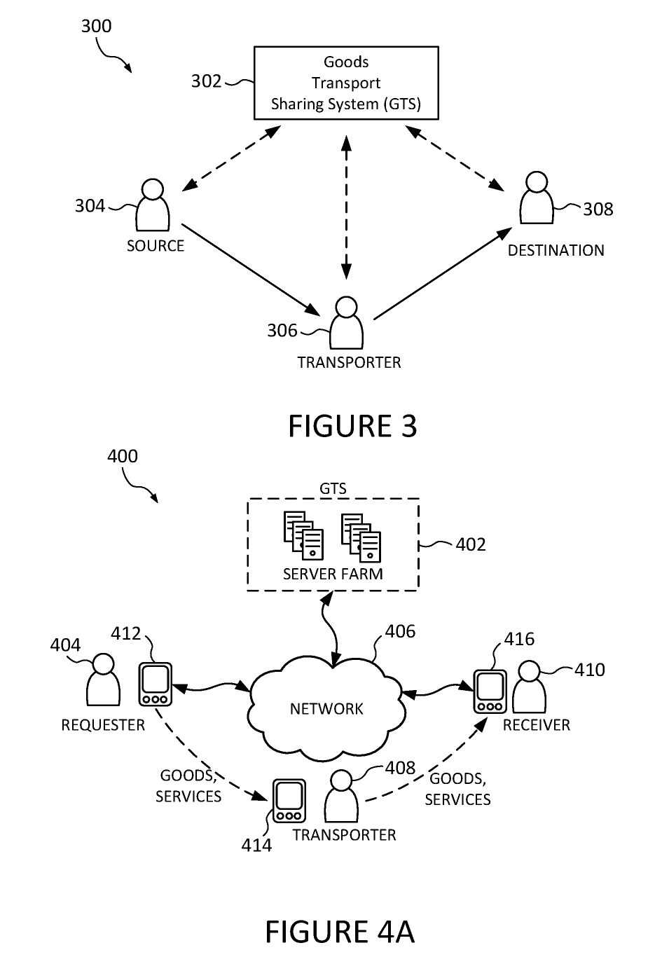

FIG. 3 shows an example Goods Transport Sharing (GTS) basic environment utilizing the computing device of FIG. 2. In various embodiments, the GTS environment 300 includes a GTS communication and computing system 302, a requesting source 304, a service provider transporter 306, and a destination 308.

In various embodiments, the requester 304 may send a request to the GTS system for transportation of goods or packages, such as a box, a suitcase, printed matter, and the like to a destination, such as a house, apartment building, high-rise buildings, a person at an office, and the like. Various unrelated and unassociated transporters may also register with or declare their current availability or their availability at a definite future date and time to the GTS system. The GTS system 302 may then match one or more requesters with one or more transporters. The GTS may charge the requester some amount of money based on the size, weight, nature, and other characteristics of the goods he wants to transport and pays the transporter a portion of the price the requester was charged based on various criteria such as time duration for transport, quality and safety of transport, and other criteria. The balance of the charged price may become the revenue of the GTS operators. Typically, the requester and the transporter are unrelated private persons willing to enter into such commercial transaction. The transporter may then deliver the goods or packages to the destination or receiving person 308. The receiver and/or the transporter may notify the GTS of the time of delivery. The GTS may in turn confirm receipt of the package to the requester and close the transaction.

In various embodiments, the GTS may provide package tracking using an Identifier (ID) constructed from the name or phone number of the requester, the transporter, or the receiver, or a combination of the above. Those skilled in the art will appreciate that the tracking ID may be generated based on many other quantities such as time, date, route, registration ID (for example, assigned by the GTS to the requester and/or transporter when they register or contact the GTS for service). In some embodiments, a requester and/or a transporter may be asked to register as customers of the GTS and be assigned a permanent user ID, while in other embodiments, the service may be offered on an case-by-case basis with a temporary ID that expires when the transaction is completed.

Generally, the requesters, transporters and receivers (at destination) are ordinary people not in professional transport business who contract together in the form of one-time or repeating transactions to use transport capacities of private vehicles and people to move goods for other people for a fee. This transport sharing scheme increases the utilization and efficiency of the private transportation system by using excess capacity when certain conditions, such routes and schedules are successfully matched between requesters and transporters. The transportation or delivery may be performed using any type of vehicles including bicycles, motorcycles, passenger cars, vans, pickup trucks, large cargo trucks, airplanes, trains, boats, horses, public transportation, and the like, or no mechanical transportation at all, making the delivery on foot.

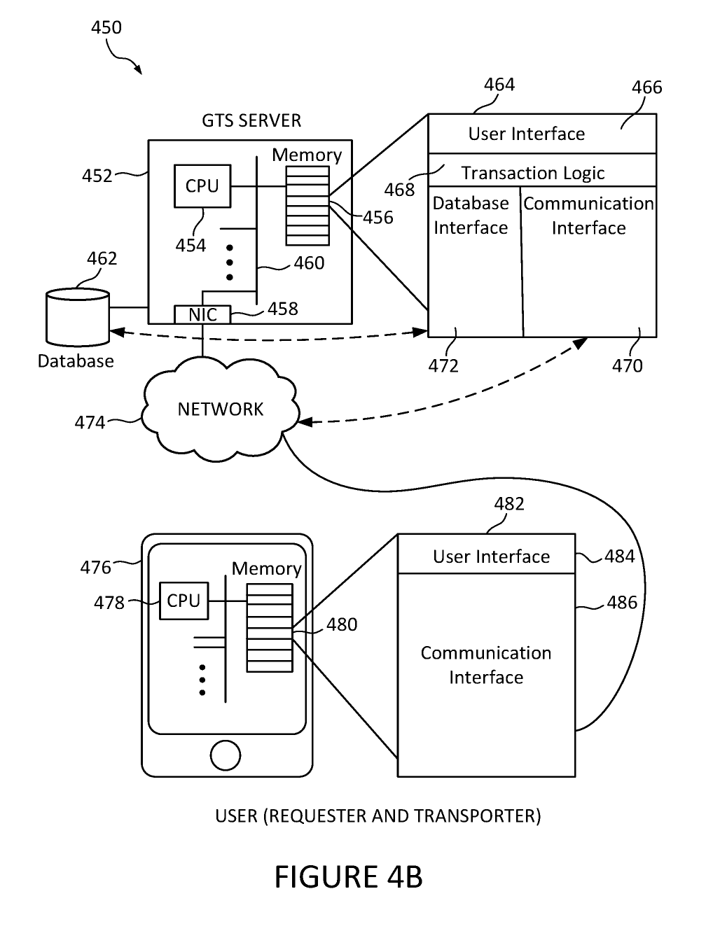

FIG. 4A shows an example GTS system in environment of FIG. 3 using mobile devices and servers similar to those shown in FIGS. 1 and 2. In various embodiments, the GTS environment 400 includes GTS system 402 coupled with a computer network 406, requester 404 and his associated computing/communication device 412, a transporter 408 and his associated computing/communication device 414, and receiver 410 and his associated computing/communication device 416, all coupled with the network 406.

In various embodiments, the GTS system 402 may include both local and remote server farms to handle the communication and computation load across cities and countries. The GTS system may further include database systems and storage coupled with the server farms to store the various information associated with the various transportation transactions, including user information, user profiles, route information, timestamps, accounting information, current status of an ongoing transaction, historical transactional data, statistics related to transportation transactions such as number of requesters and providers and average transportation distances, and the like.

In various embodiments, the GTS servers and the mobile computing devices used by the requesters are similar to the computing devices described above with respect to FIGS. 1 and 2. Those skilled in the art will appreciate that various hardware and software components and devices may have some, all, or more components than those shown in FIGS. 1 and 2 without departing from the spirit of the present disclosures.

In various embodiments, the requester 404 may contact the GTS system 402 using his device 412 via the network 406 to request transport for a particular good to a particular destination. In some embodiments, the GTS may ask him to register as a user and create an account to use the services offered by GTS. In other embodiments, the requester may only need to create a temporary account for the transaction at hand, which account will expire after the current transaction is concluded. The requester may also schedule a transportation service for a future date or for a regular transport need such as weekly or daily.

In various embodiments, the transporter 408 may contact the GTS system 402 using his device 414 via the network 406 to offer his transport services for various goods and services to the public. The transporter may include various capacities and characteristics of his transportations service, such as maximum size, maximum weight, maximum transportation distance, types of objects, dates and times the service is offered, and the like. In some embodiments, the GTS may ask the transporter to register as a service provider and create an account to provide transportation services requested by other users. In other embodiments, the transporter may only need to create a temporary account for the transaction at hand, which account will expire after the current transaction is concluded. In some embodiments, the transporter may be an individual who uses public transportation, such as buses, trains, and airplanes, but can still pick up and deliver packages on his trips. The transporter trips may be for other and unrelated purposes than just to deliver packages for a requester. For example, the transporter may use public transportation to go to work every day, but can sometimes also carry, based on a requester's request via the GTS, a packet of documents, a box of food, tools left behind by a requester, clothing, or other merchandise as a side function unassociated with the main purpose of his trip.

In various embodiments, the requester and/or the transporter may create a bid for the transportation service. For example, the requester may bid for a certain price and the transporter that can meet that price is awarded the transaction. Similarly, the transporter may offer his services at a particular price for requesters to consider. The bidding facility may create a two-way competitive interaction between multiple requesters and multiple transporters, generally driving down price and increasing the overall utilization and efficiency of the system.

In some embodiments, different tiers of transportation may be offered, such as Economy, Regular, and Premium. For example, a Premium transportation service may include immediate pickup and delivery of goods in exchange for a higher price, while an Economy option may offer a delayed pickup and delivery based on the transporter's schedule in exchange for a lower price. Those skilled in the art will appreciate that other tiers of service may be offered based on timing, price, quality of transport, risk of damage to goods, and services offered in addition to the transportation service, such as moving the goods around at the destination or assembling a system like furniture or bicycle.

In various embodiments, the delivery of goods may not involve any transportation, but rather a holding or keeping function, in which a service providing user unassociated with a requester agrees to hold an article, such as keys, clothing, books, a message note, or any other article, object, or goods given by the requester to be delivered later to a receiver. For example, a requester may be leaving town and wants to ensure that keys to his office are delivered to a colleague who will be at a location a few hours later. The requester may drop off his keys with a delivery service provider or holder (similar to a transporter but without transporting anything, just holding) at a designated location, such as the holder's place of work, business, or home. A few hours or days later, the receiver may come by the holder's location to pick up the keys. This is a delivery service without any transportation being involved on part of the service provider or holder.

In other various embodiments, the transporter may transport and/or deliver goods or articles from a particular person to another particular person. In this kind of hand-to-hand or end-to-end delivery service, more information may be needed to specify a particular person to reduce risk of mis-identification. This information may include, full name and address of the recipient, a picture of the recipient, and checking a pictured ID of the recipient prior to delivery of the item.

In some embodiments, the requester may need help from multiple parties for the same task. Similarly, a transporter may offer delivery services to requesters, via the GTS, that includes help from people other than the transporter and the requester. In some embodiments, the transporter may provide helpers himself as part of his offered transport service. In these embodiments, the requester may receive the services of the transporter and the helpers via a single request to GTS. In other embodiments, the helpers may enlist with GTS independently and separately from the transporter. In these embodiments, upon request from requester, the GTS may coordinate the transporter/deliverer and the independent helpers as part of a single transaction for the requester. In other embodiments, the requester may make two or more requests/transactions to the GTS, one for each party he wants to engage. In these embodiments, the requester himself is coordinating the multiple transactions. For example, a truck owner may offer transportation services including the help of helpers to move furniture or other large items. In other embodiments, the GTS may coordinate multiple parties for one transaction. For example, the requester may request the transportation of a large refrigerator. The GTS may then match a service provider having a truck and other service provider who offer only manual help with the requester, all parties being unassociated with each other. In this example, the truck owner may meet with the helpers at the source of transportation to help load the refrigerator.

In various embodiments, the GTS allows a seven days a week, 24 hours a day delivery and transportation of goods, because generally no businesses are needed for the transportation and/or delivery. Ordinary people collaborate, via GTS and associated apps, to transport and deliver goods. Businesses are not excluded from participation, but are not needed in the general case. As such, regular business hours do not restrict the operation of the GTS.

FIG. 4B shows an example hardware and software architecture of the example GTS system in environment of FIG. 4. In various embodiments, the system architecture 450 includes a GTS server 452 coupled with a database system 462 and having a CPU 454, memory 456, bus 460, and Network Interface Card (NIC) 458 coupled with network 474. The memory 456 may include a system GTS software application 464 having a user interface component 466, a transaction logic component, a database interface component 472, and a communication interface 470. The architecture further includes a user computing device 476 having a CPU 478, and memory 480. The memory 480 may include a user GTS software application or mobile app 482 having a user interface component 484, and a communication interface 486 coupled with the network 474.

In various embodiments, the GTS server is similar to the computing devices described above with respect to FIGS. 1 and 2, in relevant portions. The system GTS software application may be designed specifically to respond to and server the users of the GTS system. The system GTS software may include a user interface to allow users of the GTS to login, connect, or otherwise interact with the GTS system to make requests or offer transportation services. The user interface may be a GUI, a command line interface, a browser-based interface, a combination of these, or any other type of user interface suitable for remote connection to the GTS system. The user interface may ask the users to register by entering their identifying information such as name and address, enter service-related information such as package delivery, dates, source and destination addresses, and the like. Generally, the source and destination addresses may be provided as GPS position information or other map-based position information that allows the transporter to know where to go for pickup and delivery.

In some embodiments, the user interface component may also provide or display a unique ID to the user for future reference and identification of the transaction. In some embodiments, the user interface may help create an account for the user including an account number, payment information, history of transaction, a rating indicating the user's rank in terms of desirability to do business with, preferences, statistics, and other user profile information usable in serving, evaluating, and pricing future transactions.

In various embodiments, the system GTS software application 464 may also include a middle layer transaction logic 468 which performs the core business functions for transportation sharing. Such functions may include parsing user inputs, including information provided by the requesters and transporters, to match suitable requesters with transporters. Another function may be matching the requesters and transporters based on a number of factors, such as price, quality, schedule, transport capability, source and destination addresses, user profiles, user transaction history, statistical data, time of day, traffic congestion, routing considerations, and other relevant criteria and constraints. The transaction logic component may apply various predefined logic and business rules to the factors to come up with a decision or recommendation regarding which requesters and transports are the best match. The transaction logic may also work with the interface layer 466, the database interface 472, and the communication interface 470 to obtain data from the user and from the database and to direct communication of information based on the transaction rules. The transaction logic component may also generate and/or update statistics, historical transaction data, user profiles, and other data generation and usage functions as needed. The transaction logic may also include accounting functions to receive and make payments, keep track of transaction progress and status, maintain or update account information, among other functions.

In various embodiments, the system GTS software may also include the database interface 472 to store user profile, statistical and transaction history data, user account information, payment information, and other long-term information.

In various embodiments, the communication interface 470 may be used to communicate information across network 474 using the NIC 458. This interface may implement various mid-level communication protocols to send and receive information. Those skilled in the art will appreciate that the communication module 470 may be part of the system communication stack as part of the operating system of the server, such as those described in the ISO-OSI (International Standards Organization-Open System Interconnect) communication model. The transaction layer may send the data it needs sent to other actors, such as the requester or the transporter, to the communication module, which may then package the data in the format needed by the operating system's communication stack to be sent out on the network 474 via the NIC.

In various embodiments, the system GTS software may be implemented by a hardware and/or software system using one or more software components executing on the illustrative computing device of FIG. 2. One or more functions may be performed by each software module recorded on a medium such as an optical disk, magnetic tape, volatile or non-volatile computer memory, and the like, or transmitted by various communication techniques using various network and/or communication protocols, as described above with respect to FIG. 1. For example one or more separate software components may be used for each of the functions in the GTS system such as registering users, creating accounts, handling payments, applying business rules to collected data, matching requesters and transporters, scheduling transportation, communicating results and status to various actors, supplying data to the user interface, generating and/or updating user profiles, generating and/or updating statistical data, generating and/or updating historical transaction data, tracking transportation transactions, and the like. Those skilled in the art will appreciate that the various functions may be performed by one integrated functions, and conversely, the same function may be performed by multiple cooperating software and hardware modules, such as the communication and database interface modules.

In various embodiments, the system GTS software may be implemented as a standalone set of software modules forming a specialized application, while in other embodiments, it may be implemented as the back-end of a webserver to utilize standard web protocols and programming languages, such as HTML, SMGL, XML, XSL, XSLT, CSS, and the like. In other embodiments, the system GTS software may be a combination of proprietary software modules and web-based applications.

In various embodiments, the user (requester, transporter, or receiver) device may include a small dedicated software application, or GTS app 482, to communicate with the system GTS to arrange transportation sharing. The user GTS app may include the user interface 484 and the communication interface 486 to connect or login to the system GTS via network 474. The user interface may provide various login dialog boxes, user input fields, picklists, dropdown boxes for selection of various options, user profile or contact information viewing and/or editing, and the like. The user typically opens the GTS app on his mobile device, such as a cell phone or tablet, to login to the GTS system and make a request or update information and also to receive transaction number, make payments for transport sharing, purchase insurance for his package during transportation, check the status of delivery, and the like. In some embodiments, the user interface may an integral part of the standalone user GTS app, while in other embodiments, the user interface may be via a standard browser that loads the GTS webpage to login and perform the functions described herein from the user perspective.

In various embodiments, the communication interface 486 may be a mid to high level protocol (for example, application level protocol in the ISO-OSI model) to communicate specifically with the GTS system in a format specifically designed for this communication that carries application-level data and information. In other embodiments, the communication interface may be part of a GTS webpage or website loaded onto the user device via a standard web browser, such as Internet Explorer (IE)® or Google Chrome®.

In some embodiments, the processing of user requests and transactions take place on the system GTS side 464, while in other embodiments, at least some of the user request processing may be performed on the user GTS app side 482. For example, the user may enter a package size and destination from his mobile device and the GTS app on the mobile device may provide a price quote without the user logging onto the GTS system to make a formal request. Similarly, the GTS app may ask, guide, and acquire the various information needed for transportation (for example, names, addresses, package size, distance, insurance needs, etc.) without connecting to the GTS system. Once the basic information is gathered, then the GTS app may transmit the information to the GTS system for finding a suitable transportation match. In other embodiments, the user input may be made directly onto the GTS website loaded on the mobile device without any processing, other than obtaining input via the user interface for immediate transmission, on the user GTS app. In this configuration, the user side GTS app may not be necessary.

In still other embodiments, the user GTS app may be one node in a distributed network of apps that collectively access a central database for storing or retrieving transport transaction data and adjust prices, schedules, transporter and requester assignments, and other transport parameters described herein in a distributed manner, as opposed to a central GTS system managing and coordinating every aspect of the transaction. In these embodiments, the use side GTS app may be considerably more complex and need additional software modules or layers for arbitration of conflicts in assigning transporters and schedules, real-time data exchange with other proximate nodes, and transaction number assignments and tracking, payment handling, event notifications, transaction scheduling, pickup, delivery, confirmation, among other necessary computing and information needs.

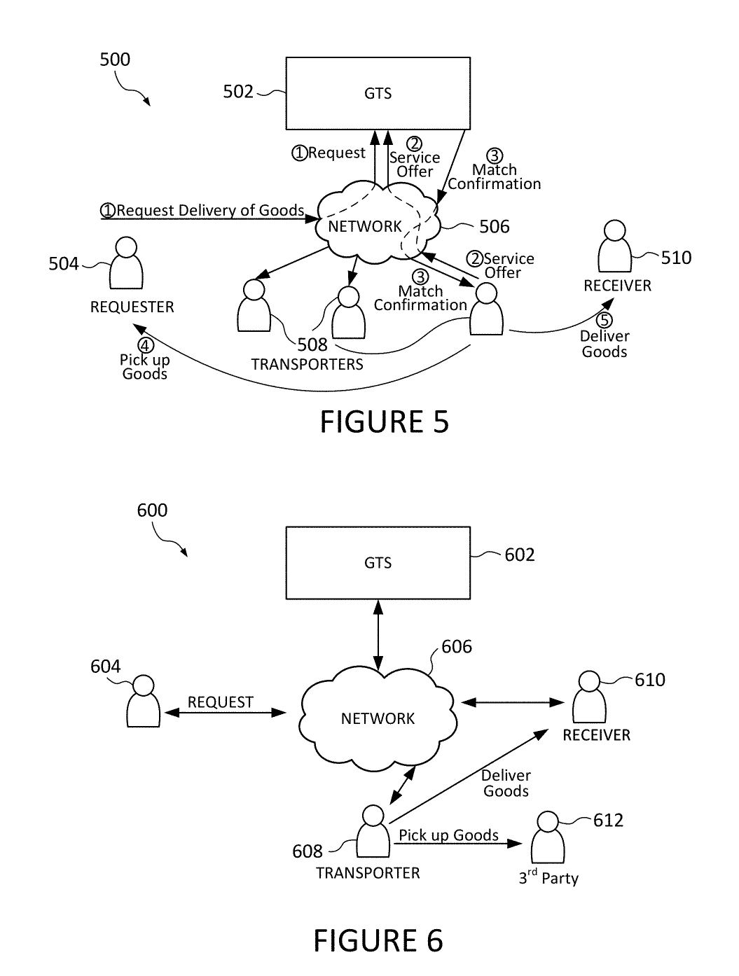

FIG. 5 shows an example interaction for delivery of goods and services in the example GTS environment of FIGS. 4A and 4B. In various embodiments, the transportation transaction 500 includes the GTS system 502 coupled with network 506 to accept requests from requester 504 for transportation of goods by transporters 508 to a receiver 510, all coupled with network 506.

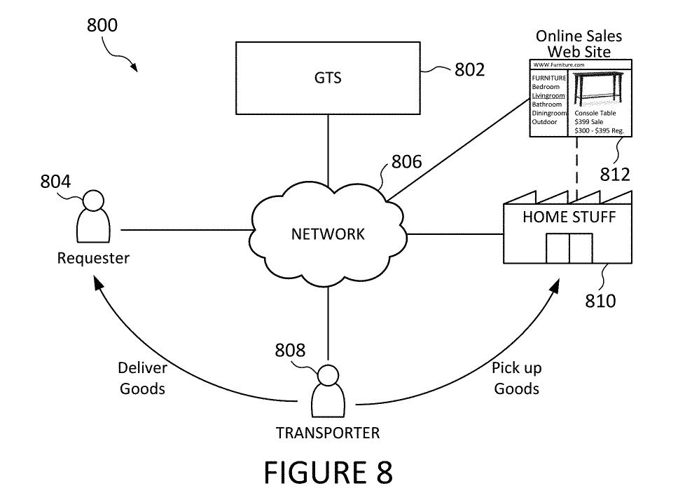

In various embodiments, in operation the requester may start the transaction, possibly in parallel with the transporters 508, by sending a request to the GTS system for transportation of goods. The request data may be transmitted to the GTS by many techniques including using a web browser to login to a website for the GTS system, using a standalone application (for example, a mobile app) designed to communicate with GTS, emailing or texting the request to a predefined email or text address, respectively, and the like. Meanwhile, various transporters may also login to the GTS system separately and independently of any requester and offer various transportation services, schedules, and capabilities. In some embodiments, the GTS system may record both the requests and service providers' offers in a database storage, local or remote, for matching as early as two or matches are found. The GTS may have a different table in the database, one for the requests, and one for the service providers. As requests and offer of service come in, the GTS may match them based on various criteria such as schedule, source, destination, size of goods, quality of service (for example, speed, risk, reliability, history, and the like), distance, transport being within a city or between cities, price, time of year, time of month, time of week, time of day, size and type of packet to be transported, weight of packet, profiles of requester and transport provider, history of GTS service usage by requester and transport provider, number of delivery hops (further described with respect to 6-8), any third parties involved (further described with respect to FIG. 6), any commercial online purchases involved (further described with respect to FIG. 8), and any other factors or criteria that may affect the transportation transaction in some way.

With continued reference to FIG. 5, the requester 504 may request delivery of goods from his home or work to a destination. This request is shown by the circled number 1. The request is delivered to the GTS via the computer network 506. In parallel, a transportation provider 508 may offer his transportation services to the GTS, as indicated by circled number 2. The GTS system match the request with the transporter's service and send a confirmation to both the requester and the transporter as signified by circled number 3 (only confirmation to transporter is shown to avoid a cluttered diagram). Once the transaction is accepted by both parties, the transporter goes to the requester's place of origin of the goods (indicated by circled number 4) to pick up the package, and deliver the goods to the receiver 510, as indicated by circled number 5.

As an illustrative example, consider a traveler who is going to Portland from Seattle. The traveler may login to the GTS system as a transport service provider and offer to carry a package no bigger than 2′×2′×2′ and no heavier than 25 pounds. His schedule is declared as taking off at 6:30 PM to be in Portland by about 9:30 PM. He can pick up the package in a radius of 12 miles of Seattle downtown, deliver within 6 miles of Portland downtown, and charge a flat fee of $30 within the specified package size. The GTS system may then match the above criteria with one or more requests from Seattle area and notify any such requesters. Once the deal is accepted by the requester(s), he is charged a fee, which is higher than the $30 fee requested to generate revenue for the GTS operators. For example, the fee charged may be $50, with $30 going to the service provider and $20 going to the GTS. The GTS system may then update the requesters and providers' profiles and service histories, update the transaction statistics, and other data as needed.

As another example, consider a traveler going from New York to Los Angeles, who enlists with GTS or notifies GTS that he is making this trip at 11:00 PM tomorrow and is willing to take a package of no bigger than 12 lbs. with him for pick up at the Los Angeles airport or within a radius of two miles of the airport. If someone in New York also notifies the GTS that he is looking for an overnight delivery of a small package to Los Angeles, then GTS can match these two participants.

FIG. 6 shows an example interaction with a third party in the example GTS environment of FIGS. 4A and 4B. In various embodiments, the transport transaction 600 includes a GTS system 602, a requester 604, a transporter 608, a receiver 610, and a third party 612, all coupled with a computer network 606.

In various embodiments, the transaction 600 may include more than the requester, the transporter, and the receiver. It may include a third party actor as well. The requester may request a pickup of a package at a third party site and delivery to a recipient or destination. The operation works similarly to that described with respect to FIG. 5, however, the source of the package will be the third party instead of the requester himself. In this configuration, the transaction will include a request by the requester 604 to GTS via network 606, and an offer of service by transporter 608. Upon matching the request and the offer, the transporter will go the third party 612 to pick up the goods and deliver the same to receiver 610. For example, a requester may request the pickup of a luggage from an airport and delivery to a house or a hotel separate from where the requester is.

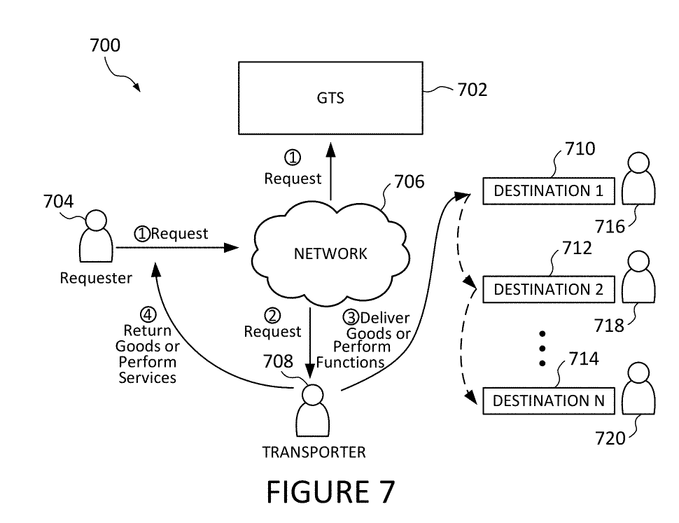

FIG. 7 shows an example multi-hop interaction in the example GTS environment of FIGS. 4A and 4B. In various embodiments, the transportation transaction 700 includes a GTS system 702, a requester 704, a network 706, a transporter 708, successive or hop destinations 710, 712, 714 associated with users/receivers 716, 718, and 720, respectively.

In various embodiments, requester 704 may send a request, indicated by circled number 1 to GTS system 702 via network 706. The transporter 708 may be matched and assigned the request, signified by circled number 2. The transporter may then pick up the goods from a designated source, whether the requester or third party (only requester shown here for simplicity), and deliver to multiple destinations or hops 710, 712, and 714, as signified by circled number 3. The transporter may also perform simple services at any of the points of pickup or delivery, such as simple assembly of a device or furniture, packaging, unwrapping, simple device or furniture installations, and the like. Generally, the services performed by a transporter may be non-skilled or low-skilled services such as the examples given above. In some embodiments, the transporter may pick up goods or packages from sources other than the requester and deliver back to the requester, as the destination, as indicated by circled number 4.

In some embodiments, the transaction may include several pickups and deliveries from multiple sources and destinations and also include the performance of simple services at one or more of the locations visited by the transporter, as described with respect to FIGS. 6 and 7. For example, a transporter may go to several pickup points, pick one piece of a device or furniture from each, bring them back to the requester and assemble the pieces at the requester's place.

In still other embodiments, the same transaction may include multiple requesters and/or transporters to perform a more complicated pickup and delivery transaction, possibly including several pickup and/or destination points. For example, two requesters may make a joint request for delivery of two sets of furniture from three different stores. In turn, three different transporters may each pick up one piece of the furniture from each of the three stores and deliver them to the two requesters. The GTS will coordinate the requester and the transporters using same transaction ID, and same charges collected and distributed between the three transporters once the transaction is complete.

In some embodiments, a business may use transporters, the same or different ones, on a regular schedule, such as daily at noon, to deliver food to its employees on a job site. For example, a construction business may have a regularly scheduled request to pick up sandwiches and pizza at noon from three different food providers to a construction job site. In this example, three transporters may be used, each to pick up food from one of the three stores for delivery to the same destination, namely, the job site. The scheduling, coordination, data handling, data generation, and data updates are all done by the GTS hardware and software as described above with respect to FIG. 4B and other places herein. In some embodiments, these operations may be performed in real time as data becomes available. The GTS system operations may also be performed on a scheduled basis, for example, regularly, or according to a requested or available schedule.

FIG. 8 shows an example interaction with an online sales outlet associated with a local store for delivery of goods and services in the example GTS environment of FIGS. 4A and 4B. In various embodiments, the transaction 800 includes a GTS system 802, a requester 804, a network 806, a transporter 808, a commercial establishment 810, and an online sales facility or website 812 associated with the commercial establishment.

In various embodiments, the requester 804 may go online to a website of a commercial product seller, such as Home Depot® or Wallmart®, and buy a merchandise that may or may not be available at the local physical outlet of the same commercial store. The transporter is then assigned the task of picking up and delivering the merchandise, when available, from the local store and deliver to the requester. In some embodiments, the commercial seller may contract with the GTS operators to ship the purchased merchandise to the local store, even if normally not available in the store, for pickup by the transporter. In other embodiments, the commercial seller may sell the same merchandise both online and in local stores. Once the online purchase is complete, the sales data and purchase receipt may be transmitted to the purchaser/requester for pickup from local store, rather to be shipped from another warehouse to the purchaser days later. The purchase receipt and other merchandise identifying information may be provided to the GTS by the requester, which in turn transmits it to the transporter for pick up at the local store and delivery to the requester. This way, instead of ordering online and waiting several days to receive the merchandise through the mail, the purchaser can get his merchandise within hours, delivered by the transporter from a local store. In effect, the transporter acts like a delivery service for the commercial store and increases the sales and customer satisfaction in the process.

It will be understood that each step of the processes described above, and combinations of steps, may be implemented by computer program instructions. These program instructions may be provided to a processor to produce a machine, such that the instructions, which execute on the processor, enable implementing the actions specified. The computer program instructions may be executed by a processor to cause a series of operational steps to be performed by the processor to produce a computer implemented process such that the instructions, which execute on the processor to provide steps for implementing the actions. The computer program instructions may also cause at least some of the operational steps to be performed in parallel. Moreover, some of the steps may also be performed across more than one processor, such as might arise in a multi-processor computer system. In addition, one or more steps or combinations of steps described may also be performed concurrently with other steps or combinations of steps, or even in a different sequence than described without departing from the scope or spirit of the disclosure.

Accordingly, steps of processes or methods described support combinations of techniques for performing the specified actions, combinations of steps for performing the specified actions and program instruction for performing the specified actions. It will also be understood that each step, and combinations of steps described, can be implemented by special purpose hardware based systems which perform the specified actions or steps, or combinations of special purpose hardware and computer instructions.

It will be further understood that unless explicitly stated or specified, the steps described in a process are not ordered and may not necessarily be performed or occur in the order described or depicted. For example, a step A in a process described prior to a step B in the same process, may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” It is further understood that any phrase of the form “A/B” shall mean any one of “A”, “B”, “A or B”, or “A and B”. This construct includes the phrase “and/or” itself.

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A Goods Transport Sharing (GTS) and delivery system comprising:
server computing device having a GTS software application stored thereon and coupled with a computer network;
a database system coupled with the GTS system and configured to store information associated with goods transport transactions requested by a requesting user of the GTS system;
a user interface module associated with the GTS software application to acquire goods transport request information from the user; and
a transaction logic module associated with the GTS software application to match the goods transport request with an independent transporter unassociated with the requesting user and the GTS system.

2. The system of claim 1, further comprising a matching mobile GTS app for use on mobile computing devices associated with the requesting user and the independent transporter, to communicate with the GTS system to coordinate the goods delivery transactions.

3. The system of claim 1, wherein the GTS system comprises a server farm.

4. The system of claim 1, wherein the GTS software application comprises a multi-layered structure including a user interface layer, a transaction layer, and a communication layer.

5. The system of claim 1, wherein the GTS system is configured to store user requests for transportation of goods and store transporter offer of services in the database.

6. system of claim 1, wherein the GTS system is configured to match the requesting user's goods transport request with a transporter by searching and matching entries in the database.

7. The system of claim 1, wherein the GTS system is configured to match the requesting user's goods transport request with a transporter by matching based on multiple criteria including a package size and weight, a transportation distance, and a time of transportation.

8. The system of claim 1, wherein the GTS system is configured to generate and update user profiles for the requesting user and the transporter.

9. A method of Goods Transport Sharing (GTS), the method comprising:
receiving a goods transport request from a requesting user by a GTS system including a plurality of servers and GTS software applications stored thereon;
receiving a goods transport service offer from a transporter by the GTS system;
matching the goods transport request with the goods transport service offer;
scheduling a pickup of goods by the transporter from a place indicated by the requesting user; and
delivering the goods to a destination indicated by the requesting user.

10. The method of claim 9, further comprising generating and updating profiles of the requesting user and the transporter.

11. The method of claim 9, wherein the receiving a goods transport request comprises receiving a goods transport request from a mobile computing device having a user GTS software application execute thereon to collect and the transmit information associated with the goods transport request.

12. The method of claim 9, wherein the receiving a goods transport request comprises receiving a goods transport request for goods purchased online from an online facility associated with a local store and transporting the purchased goods from the local store to the requesting user.

13. The method of claim 9, wherein the receiving a goods transport request comprises receiving a goods transport request for delivering goods to a plurality of destinations in one transaction.

14. The method of claim 9, wherein the receiving a goods transport request comprises receiving a goods transport request for picking up goods from a third party distinct from the requesting user and delivering the goods to a receiving party.

15. A mobile computing device comprising:
a Central Processing Unit (CPU) usable to execute stored computer instructions, a memory storage unit usable to store computer instructions, and a Network Interface Card (NIC) usable to transmit and receive data; and
a user Goods Transport Sharing (GTS) software application stored in the memory storage unit configured to be executed by the CPU to receive data input by a user of the mobile computing device and transmit the input data to a remote GTS system via the NIC and a computer network, the remote GTS system usable to match a request for goods transportation by the user with a transportation service offered by a transporter.

16. The mobile computing device of claim 15, wherein the user GTS software application comprises a multi-layered structure including a user interface layer and a communication layer.

17. The mobile computing device of claim 15, wherein a user interface layer of the GTS software application is configured to collect information associated with the goods transportation request, the information including transportation schedule, transportation source and destination, and size and weight of a package of the goods.

18. The mobile computing device of claim 15, wherein the remote GTS system is configured to match the user's goods transportation request with the transporter by matching based on multiple criteria including a package size and weight, a transportation distance, and a time of transportation.

19. The mobile computing device of claim 15, wherein the remote GTS system is configured to generate and update profiles for the user and the transporter.

20. The mobile computing device of claim 15, wherein the goods transportation request comprises a request for picking up goods from a third party distinct from the user and delivering the goods to a receiving party.
